(19) United States
(12) Patent Application Publication
(10) Pub. No.: US 2010/0062519 A1
(43) Pub. Date: Mar. 11, 2010

(54) Portable organ and tissue preservation apparatus, kit and methods

(76) Inventors: Thomas D. Franklin, JR., Plano, TX (US); Stacie L. Hyatt, Dallas, TX (US); Howell E. Warner, Forth Worth, TX (US); Marshall Wenrich, Plano, TX (US); Marvin J. Slepian, Tucson, AZ (US); Shell Lambert, Plano, TX (US)

Correspondence Address: DUNLAP CODDING, P.C., PO BOX 16370, OKLAHOMA CITY, OK, 73113, US

(21) Appl. No.: 12/590,666

(22) Filed: Nov. 12, 2009

Related U.S. Application Data
(63) Continuation of application No. 11/640,636, filed on Dec. 18, 2006, now abandoned.

(51) Int. Cl. A01N 1/02

(52) U.S. Cl. 435/284.1

(57) ABSTRACT

An organ and tissue preservation and transport apparatus comprising a chamber, a temperature control mechanism and a system monitor. A medium bathes an organ within the chamber. The temperature control mechanism adjusts the temperature of the medium. The system monitors receiving and records the temperature of the chamber.

### CROSS-REFERENCE TO RELATED APPLICATIONS

The present application is a continuation of U.S. Ser. No. 11/640,636, filed Dec. 18, 2006, of which the entire disclosure is hereby expressly incorporated herein by reference.

### FIELD OF EMBODIMENTS

Apparatus, kits and methods for sequestering, isolating, maintaining, sustaining, preserving, and/or transporting organs or tissues are described.

### BACKGROUND

The lack of donor organ availability, particularly hearts, lungs, and livers, is a limiting factor for the number of organ transplants that can be performed. At the present time, less than 10% of patients who require a heart transplant receive a new heart, and less than 10% of patients who require a lung transplant receive one. A major consideration is the length of time that a donor organ will remain viable after it is procured until the transplant surgery is completed. The donor organ must be procured, transported to the recipient, and the transplant surgery completed within this time limit. Thus, donor organs can be used only if they can be procured at a site close to the location where the transplant surgery will take place.

A system that allows the sequestering, isolation, maintenance, preservation, and/or transport of a procured organ, tissue, or limb from a site removed from the location where the transplant surgery will be carried out requires the use of a lightweight portable device in which the organ, tissue, or limb can be transported from the site of procure to the site of implantation. Desirably, the system would allow for the maintenance of the organ, tissue, or limb in a physiologic solution or other supportive media and would allow, for one person to carry the entire assembly without assistance, and to transport it in an auto or airplane. The system would desirably be compact, sturdy and lightweight such that the loading of the organ, tissue, or limb would be simple. Additionally, the system would desirably allow for minimal spillage and also allow for substantially sterile conditions.

### BRIEF DESCRIPTION OF THE SEVERAL VIEWS OF THE DRAWINGS

FIG. 1 is a plan view of a portable organ and tissue preservation apparatus according to a first exemplary embodiment.

FIG. 2 is a schematic illustration of a portable organ and tissue preservation apparatus according to another exemplary embodiment.

FIG. 3 is a schematic illustration of a portable organ and tissue preservation apparatus according to another exemplary embodiment.

FIG. 4 is a schematic illustration of the portable organ and tissue preservation apparatus according to another exemplary embodiment.

FIG. 5 is a schematic illustration of a portable organ and tissue preservation apparatus according to another exemplary embodiment.

FIG. 6 is a plan view of a portable organ and tissue preservation apparatus according to another exemplary embodiment.

### DETAILED DESCRIPTION OF EXEMPLARY EMBODIMENTS

The following detailed description and the appended drawings describe and illustrate exemplary embodiments for the purpose of enabling one of ordinary skill in the relevant art to assemble and use an organ preservation and transport apparatus and kit. The description and drawings are not intended to limit scope or protection in any manner. While the embodiments set forth below describe the apparatus in use with an organ, it is expressly understood that other forms of tissue, including non-organ body parts, can be used with the apparatus and that they fall within the scope of the embodiments.

Many medical situations require sequestering, isolating, maintaining, sustaining, preserving, and/or transporting of an organ or tissue. Organs are often initially acquired in remote locations and transportation in a timely manner is frequently an issue of concern. The operative value of any apparatus for use in the maintenance, transportation, and preservation of organs can, therefore, be affected by many factors, including overall size, weight, complexity and other considerations.

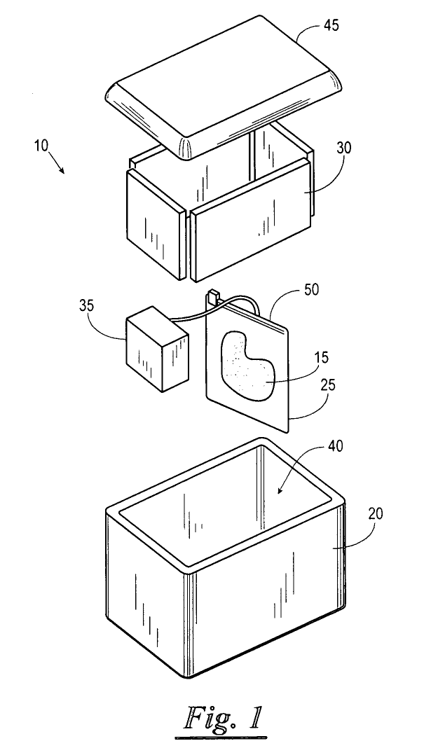

One embodiment of an organ and tissue preservation and transport apparatus 10, shown in FIG. 1, is a modification of Organ Preservation Apparatus and Method described in U.S. patent application Ser. Nos. 10/692,394, 10/756,169 and 10/756,795 which are hereby incorporated by reference in their entirety.

In this embodiment, an organ 15 is preserved and transported with a portable casing 20. The portable casing 20 maintains an internal steady temperature over an extended period of time using three main components: a chamber 25, a temperature control mechanism 30 and a system monitor 35. The organ 15 is placed within the chamber 25 and the chamber 25 is sealed to provide a substantially sterile environment for the organ 15. A medium within the chamber 25 forms a bath around the organ 15 topically cooling the organ surface. The temperature control mechanism 30 cools the medium through the flow of heat energy in or out of the system. The system monitor 35 sets, controls, measures and/or records the temperature of the portable casing 20, chamber 25 and/or organ 15.

The portable casing 20 of the organ and tissue preservation and transport apparatus 10 is a compact and readily transportable assembly in an insulated rigid container having a hollow interior 40 and a lid 45. The portable casing 20 functions to house the chamber 25, the temperature control mechanism 30, the system monitor 35 and/or any fluids and gases needed for the transport of the organ including but not limited to any nutritive or therapeutic supplemental fluid, oxygen, carbon dioxide and/or nitrogen. For example, the portable casing 20 may be a commercial cooler with a fifty quart capacity.

The materiality of the portable casing will depend on the external environment and use. The portable casing 20 should be resilient to outside environmental influences and may include elements to protect against mechanical stress/strain damage, thermal insults, moisture, excessive pressure, radiation, and/or reduced cabin pressure if in flight. Materially, the portable casing may be made of resilient materials such as high impact plastics or materials with moderate elastomer properties to resist dents and dings. Materials such as polymer or composites utilized in automotive bumpers may be used. Materials may be, but are not limited to: thermoplastics, epoxy wood, metals, laminates, and composites. The type of material selected may be based on suitability for use and other appropriate considerations. For example, reuse or one-time use of the portable casing may guide material selection.

The main components of the organ and tissue preservation and transport apparatus 10 can be mounted on a tray (not shown) and placed in the hollow interior 40 of the portable casing 20. The entire weight of the organ and tissue preservation and transport apparatus 10, including the organ 15 to be transported, is less than about 40 pounds. This weight represents an optimized combination of features and components balanced against a desire for ease of handling and transportation. It is also expected the organ and tissue preservation and transport apparatus 10 weigh less than about 35 pounds. It is also expected the organ and preservation and transport apparatus 10 weigh less than about 20 pounds. It is also expected the organ and tissue preservation and transport apparatus 10 weigh less than about 15 pounds.

Referring again to FIG. 1, the chamber 25 receives the organ 15 to be transported and/or preserved. The chamber 25 has at least one opening 50 but may include more than one opening 50. The opening 50 functions to provide organ 15 entry, organ 15 removal, preservation/suspension fluid entry and removal, insulation of air, and/or other similar functions. The opening 50 may be sealed by the use of closures, lids, or container caps including, but not limited to, screw caps, pressure seal lids, bung designs, twist ties, thermal sealed systems, multiple o-rings, washers, or other similar secure designs dependent on the function of the opening.

The chamber 25 may be made of any non-porous, sterilizable material. Materials in direct contact with the organ 15 should include bio-compatible, largely inert materials including but not limited to thermoplastics such as polyethylene, polypropylene, silicone, glass, or stainless steel.

In certain embodiments dependent upon the situation of use, the chamber 25 will include material having favorable heat transfer characteristics allowing for rapid equilibration of temperature with minimal insulation capacity.

The chamber 25 will be sized for the capabilities of housing the organ 15 and will vary in shape depending on the use. For example, the size of the chamber 25 will be smaller for the transport of smaller organs (i.e., kidney, glands, corneal tissue).

In one embodiment, the chamber 25 is a flexible container and may be formed of several layers of material. The flexible container has an opening 50 allowing a user to place the organ 15 within the chamber 25. The opening 50 can then be sealed or reversibly sealed through the use of fasteners, adhesives, clamps, straps, latches or other suitable manner such that substantially sterile conditions within the flexible container are maintained.

In FIG. 1, the chamber 25 is formed of a multilayered, thin, flexible polymeric material having a sealable opening 50. The specific material chosen for a particular embodiment can vary based on several considerations but need only be biocompatible and sufficiently durable and conform to OPTN/UNOS Policies. For example, the chamber 25 may provide a triple sterile barrier to protect with one sterile rigid container considered one of the triple barriers. However, it should be understood that in situations in which the organ and/or tissue is a liver or lung, the rigid container is not required under OPTN/UNOS Policies. Furthermore, a chamber 25 housing solely tissue need only require a leak proof plastic bag not embedded in ice.

In another embodiment (not shown), the chamber 25 is a plastic bin manufactured by injection molding using a polycarbonate resin suitable for medical use such as Makralon® Rx-1805, ULTEM® 1000, or clear ABS. This thermoplastic resin is a transparent polycarbonate formulated to provide increased resistance to chemical attack from intravenous (IV) fluids such as lipid emulsions. Other biocompatible injection molding resins are also contemplated for use herein. A cover can be sealed to the chamber 25 by a standard O-ring or suitable gasket. Suitable fasteners, adhesives, clamps, straps, latches, or other expedients can be used to hold the cover in place so that the chamber 25 is sealed from the atmosphere and substantially sterile conditions can be maintained.

In another embodiment (not shown), the chamber 25 is a closed surgical steel basin covered with a substantially sterile tempered glass or plastic lid. In this embodiment, the lid can be sealed to the steel basin through the use of fasteners, adhesives, clamps, straps, latches or other suitable manner such that the chamber 25 is sealed from the atmosphere and substantially sterile conditions are maintained.

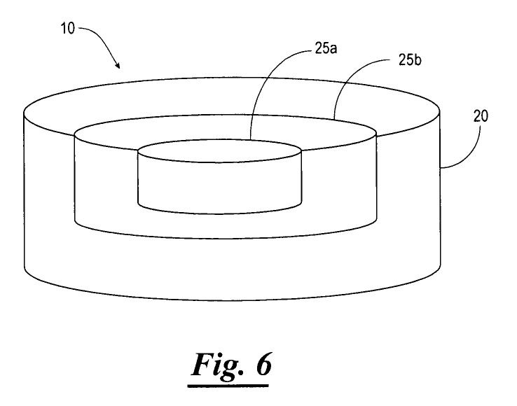

In another embodiment as shown in FIG. 6, the organ and tissue preservation apparatus 10 is composed of multiple chambers shown for purposes of clarity as a first chamber 25a and a second chamber 25b within the portable casing 20. In this embodiment, the first chamber 25a houses the organ, and the second chamber 25b contains the temperature control mechanism. It should be understood that additional chambers 25 may be included with multiple surrounding or concentric chambers 25 of each function. For example, there may be two concentric/parallel/tandem chambers housing the organ. There may also be additional chambers 25 for housing the temperature control mechanism 30. For example, there may be a first chamber 25a providing direct temperature exchange and a second chamber 25b functioning to decrease the thermal gradient from the first chamber. Alternatively, a second chamber 25b may function as a reservoir for temperature-controlled fluid or as a source for new fluid.

The material of the second chamber 25b housing the temperature control mechanism 30 may be composed of materials with heat transfer characteristics that differ from that of the first chamber 25a. For example, the second chamber 25b may include materials affording poor heat transfer such as hi-density polypropylene. Materials may be components with filters to contain gas or vacuum cells or regions, decreasing heat transfer materials may contain foamed or other particular materials to similarly limit heat transfer. Materials may be multi-layered with interposed spaces filled with air, gas or vacuum.

Chamber 25b may contain one or more openings 50 functioning for the inlet or outlet of a heat-conducting medium. The heat conducting medium may be stagnant or circulating. The exchange rate of the fluid may range from 1 mL/min to 4000 mL/min although they may extend beyond dependent upon use.

The portable casing 20 and/or chamber 25 may be coated or laminated with a variety of materials including, but not limited to, anti-thrombotic coatings, anti-inflammatory coating, anti-microbial coatings, free radial scavengers, and/or coatings functioning to reduce tissue adhesion. The admixed materials and agents for release may include and are not limited to: antibiotics, antifungal, anti-inflammatories, anti-tumor agents, anti-adhesive agents, electrolytes, metabolites, colloidal agents, albumin, antiviral agents, anti-protozoans or other therapeutic agents to assist in maintaining organ viability or minimizing organ rejection. Such coatings may be passive or active-responding to internal or external stimuli. For example, an anti-microbial agent may be released on demand via an externalized trigger mechanism. A passive coating may act as a sustained release or controlled-release reservoir. For example, a continuous low-level of anti-coagulant may be released or leached into the surrounding media. Material containing free radical scavengers could be used to minimize the detrimental effect of oxygen free radicals. For example, a biocompatible barrier layer can optionally be applied to the interior lining of the chamber 25 to protect against development of endotoxins due to shedding of particles or the like. One or more suitable compounds can be used in the biocompatible barrier layer, such as medical grade Silastic® organosiloxane elastomer material, available from Dow Corning Corp. This compound comes in many forms including a liquid material that can be painted onto any surface and dried by exposure to air or UV light. Once applied it provides a liquid tight barrier that does not leach, protects against contact at a biochemical level between compounds on either side and has repeatedly been shown to be biocompatible for long periods, as when used as a part of numerous permanent implants in a number of medical fields.

In use, the chamber 25 is disposed in the portable casing 20. The chamber 25 can be placed in the portable casing 20 in a manner that maintains the organ 15 in a substantially shock resistant state. The chamber 25 may contain slings, bands, webs, bolsters or foam or other material to suspend or support the organ, preventing contact with the chamber interior wall although the use of such materials may be unnecessary with the use of the bath.

The chamber 25 contains a suspension medium for maintaining and transporting the organ 15. The medium may be liquid, gas, or a mixture of both. Suitable medium will be selected for a particular embodiment depending on several considerations including the type or types of organs and/or tissues with which the chamber 25 is designed to be used. The medium can be a complex mix of buffers and small molecular weight molecules providing nutrients, maintaining pH and chemically slowing metabolism. Further, the medium may function to chill the chamber 25 to the low temperature at which the fluid is maintained. For example, the medium may be comprised of solutions such as “Wisconsin solution” which can be obtained from several sources, including ViaSpan® solution, commercially available from Barr Laboratories. The medium can also be modified by adding an anticoagulant such as heparin, antioxidants, cardiac stimulants, anti-rejection compounds, and other ingredients.

The medium within the chamber 25 may be in stagnant, changed or exchanged during use. The medium may be circulated, mixed or otherwise agitated. The medium may be perfused (brought in and out) of the chamber 25 or super-fused such that it is brought continuously in with contemporaneous egress keeping “new” fluid in the chamber 25. The chamber may contain a rotary mixer, propeller, vibratory, ultrasonic, percussion or other mixing means. For example, the chamber may facilitate the use of an agitator. The agitator may be a projection within the chamber that rotates at varying angles such that the medium is shaken or stirred. In another embodiment, the medium is agitated using a small bar magnet. The chamber is set on top of a plate containing stationary electromagnets creating a rotating magnetic field. The rotating magnetic field causes the small bar magnet to rotate and agitate the medium. Other motorized stirrers and agitators are contemplated for use within the organ and tissue preservation and transport apparatus 10 and include, but are not limited to, rotary mixers, propellers, vibratory mechanisms, ultrasonic mechanisms, percussion mechanisms, or other mixing means.

In one embodiment, the medium also provides scavengers for oxygen (O₃) free radicals, which radicals are believed to interfere with normal cell function. One scavenger contemplated for use herein is Adenosine. Another contemplated scavenger is Vitamin E. Other oxygen free radical scavengers known in the art are also contemplated for use herein. The scavenger can be any scavenger approved for use in cardiac and other organs and tissue, perfusion, or IV fluids, now or in the future.

The scavenger optionally can be stabilized within the fluid environment. Stabilizing the scavenger within the fluid will keep the scavenger active throughout transport of the organ 15. The scavenger can be stabilized, for example, by cross-linking it to a larger carrier molecule (such as glutaraldehyde) in a way that exposes the active binding site, allowing binding to O₃. The size and chemical nature of the cross-linked molecule can be such as to protect against the Adenosine or other scavenger from being absorbed and bound by the organ 15.

Another approach is to provide the scavenger in a fixed position away from the organ 15 but within the flow of the medium. The scavenger is fixed to a platform or substrate, which can be located at a distance from the organ 15. The free oxygen radicals are picked up as the medium circulates over the platform, thus effectively removing them from contact with the organ 15. The scavenger can be fixed to a substrate such as the inner wall of the chamber 25 or another structure exposed to the medium. The platform can optionally be a fluid-permeable filter impregnated with the scavenger.

Yet another approach is to provide a time-release device to deliver the scavenger to the system over time, at a constant or varying rate. Such technology already exists for the delivery of hormones, as in an implant made from Silastic® organosiloxane material. In this case the scavenger molecule is imbedded within or dispersed in the implant. Once placed in the chamber 25, the scavenger is released from the silastic at a substantially steady release rate. As the organ 15 picks up and removes the scavenger from the fluid, the implant releases a fresh scavenger into the fluid environment, creating a renewed supply and protecting against a buildup of damaging free oxygen radicals within the medium.

Referring again to FIG. 1, the organ and tissue preservation and transport apparatus 10 also includes the temperature control mechanism 30. The temperature control mechanism 30 provides a flow of heat energy cooling the medium such as by heating and cooling. Heating may be via conductive, inductive, infrared, thermo-electric radio-frequency, resistive, solar, or chemical means. Cooling may be via evaporative, chemical, sublimation, ice, thermo-electric, coolant or active or passive refrigerant means. For example, the temperature control mechanism 30 may include cooling blocks or freezer packs or include the use of a mechanical device such as a pump. In using a pump, the pump may contain a contiguous heating or cooling thermal element. However, circulation using a pump may be continuous or pulsatile. The pump may be pneumatic, mechanical, or electrical. The pump may be roller design, linear peristaltic, centrifugal design, piston design, pressurized/air drive with appropriate valves, or turbine/rotary design.

FIG. 1 demonstrates one embodiment of the temperature control mechanism 30 comprising cooling blocks or freezer packs. The cooling blocks have a lower physical temperature limit protecting against the chamber 25 reaching temperatures that may damage the organ 15. Effective preservation of the organ 15 can be obtained at a variety of temperatures from hypothermic temperature (about 4-10 degrees Centigrade) to standard human body temperature (about 37 degrees Centigrade). The ideal temperature that the organ 15 should be held to maintain over a long period is still being investigated, but there are indications that the ideal temperature should be maintained within a narrow range and the best temperature may be higher than zero degrees Centigrade. Some contemplated temperature ranges for the organ 15 in the embodiments described are 4-6 degrees Centigrade, 10-12 degrees Centigrade and 16-18 degrees Centigrade. Any stated minimum temperature can be associated with any stated maximum temperature that is as great or greater to define a specifically contemplated temperature range.

In another embodiment of the temperature control mechanism 30 as illustrated in FIG. 6, the chamber 25a houses a first medium and the chamber 25b houses a second medium wherein the second medium is a liquid, gas, or a liquid and gas mixture that provides heat conduction. For example, the second medium may be a physiologic, water based fluid such as water, normal saline, or Krebs buffer. Additionally, the second medium may be a solution, suspension or emulsion. The second medium may be an organic-based solution utilized to conduct heat such as, for example, glycol-based solutions. If the second medium is fluid, the viscosities may range from one (1) centipoises to a thousand (1,000) centipoises.

In another embodiment (not shown), the temperature control mechanism 30 uses a convection method. In this embodiment, the temperature of the system is controlled by a discharge vent, a circulation fan and a warming fan. Cold air surrounding a removable ice container is either circulated by the circulating fan or discharged by the air discharge vent. Warm air is brought into the system by the warming fan. The speed of the fans is regulated by the system controls to maintain the desired temperature of the organ 15, chamber 25 and preservation fluid.

In another embodiment (not shown), the temperature control mechanism 30 uses an interface between two adjacent chambers. For example, the interface may be a semipermeable membrane placed between a first chamber and a second chamber. The semipermeable member allows for selective diffusion between the first chamber and the second chamber. In this embodiment, the first chamber houses the organ while the second chamber contains a dialysate. The temperature of the dialysate is controlled through the use of a heat pump, cooling blocks or other similar mechanism either within or substantially surrounding the second chamber. The dialysate is circulated by convection, the use of a pump, a concentration gradient or other similar mechanism and diffuses across the semipermeable membrane thus affecting the temperature of the first chamber. For example, if the temperature of the dialysate is lowered then diffusion across the semipermeable membrane would in effect lower the temperature of the first chamber. This embodiment is advantageous in that the semipermeable membrane can allow for selective diffusion and thus additional elements that will not diffuse across the semipermeable membrane may be included within either the first chamber or the second chamber. For example, the second chamber may contain potent buffers that will not diffuse across the semipermeable membrane into the first chamber.

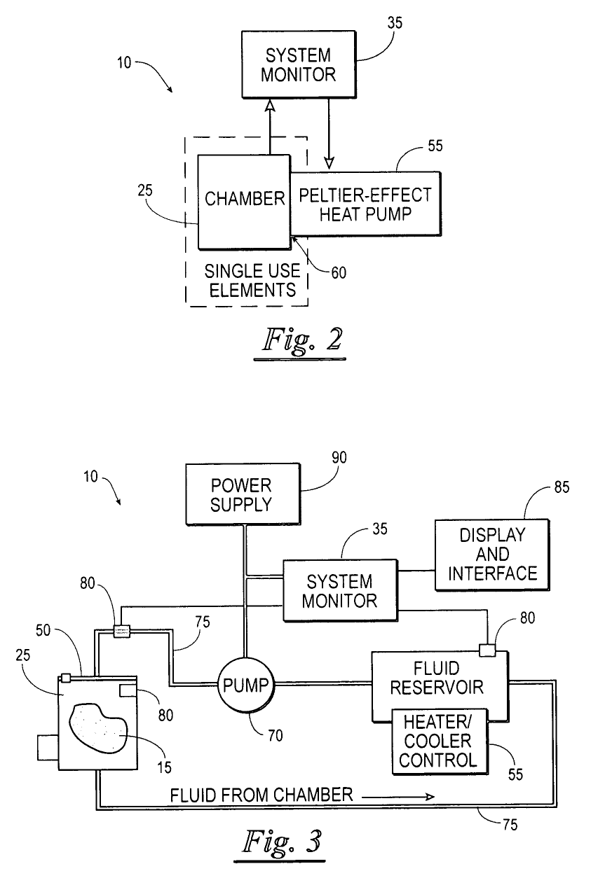

Alternative organ and tissue preservation and transport apparatus 10 are shown in FIGS. 2 and 3 with other embodiments of the temperature control mechanism 30 using a Peltier-effect thermoelectric heat pump 55 for regulating the temperature at which the organ 15 is maintained. Examples of Peltier-effect heat pumps are disclosed in U.S. Pat. Nos. 6,548,750 and 6,490,870, which are hereby incorporated by reference in their entireties. The Peltier-effect heat pump 55 does not require a fluid refrigerant or heat sink. It can be a solid-state device and can function with no moving parts.

The temperature of the Peltier-effect heat pump 55 may be controlled through the use of the system monitor 35 and electronic system feedback in conjunction with temperature sensors. The system monitor 35 provides a signal to the Peltier-effect heat pump 55 to modify the temperature of the fluid as needed by either maintaining the temperature at the sensor constant or providing a suitable temperature profile.

The Peltier-effect heat pump 55 can be used to either heat or cool the medium merely by reversing the flow of electricity in the Peltier-effect heat pump. If the portable casing 20 is being carried in a very cold environment or used to re-warm the organ 15 near the end of transport, it can heat the medium.

The Peltier-effect heat pump 55 can also be used to provide a heating or cooling profile for the organ 15. The organ 15 normally will be procured at a temperature between ambient temperature and normal body temperature, cooled to a transport temperature and either preheated before being implanted or reheated to body temperature by the recipient's metabolism as the organ 15 is implanted and starts to function.

While the appropriate temperature profile is presently being studied, it is contemplated that the organ 15 can be placed in the chamber 25, cooled at a desired rate or following a desired temperature-time profile, transported, and then heated at a desired rate or following a desired temperature-time profile, after which it can be transplanted into the recipient. Cooling and re-heating the organ 15 in the portable casing 20 as it is being transported can save some of the time between procuring the organ 15 from the donor and transplanting the organ 15 into the recipient. This may extend the transportation time the organ 15 can withstand and still be transplantable, if the desired heating or cooling cycle requires a substantial time to complete.

Referring first to FIG. 2, in this embodiment the Peltier-effect heat pump 55 is thermally linked by a conducting wall 60 to the chamber 25 cooling the conducting wall 60 and will cool the chamber 25 and its medium content. A liquid, heat-conductive material, such as an aqueous gel, may be placed between the Peltier-effect heat pump 55 and chamber 25 surfaces. If the heat-conductive surface of the Peltier-effect heat pump 55 is congruent to the chamber 25, the liquid heat-conductive material can be contained so it will not leak out. In another embodiment, the liquid heat-conductive material can be liquid as applied, then fuse, cure, or otherwise harden, or become viscous to form a heat-conductive solid interface between the chamber 25 and the Peltier-effect heat pump 55.

Another embodiment uses a heat-conductive wall of the chamber 25 as one component of the Peltier-effect heat pump 55. This avoids the need to provide a separate wall and cooling element.

FIG. 3 shows an embodiment of the Peltier-effect heat pump 55 interfacing to a separate fluid reservoir 65. The main components of this embodiment include the chamber 25, a pump assembly 70, the fluid reservoir 65, the Peltier-effect heat pump 55 and the system monitor 35. The organ 15 is placed within the chamber 25 and the chamber 25 is sealed to provide a closed loop substantially sterile environment. The pump assembly 70 forces cold medium to the chamber 25 via at least one fluid channel 75. The medium forms a bath around the organ 15 in the chamber 25 topically cooling the organ surface. The fluid channel 75 returns the medium to a fluid reservoir 65 that is adjacent to the Peltier heat loop 55.

Medium is circulated by the pump assembly 70 comprising a motor and an impeller controlled by the system controls which pumps the fluid to the chamber 25. The specific pump assembly 70 selected for a particular embodiment will depend on several considerations including the type or types of organ and/or tissues with which the organ and tissue preservation and transport apparatus 10 is being used. An example of a suitable pump assembly 70 includes a sealed rechargeable lead-acid or lithiumion battery 31, a DC brush motor 32 and an AC transformer and AC/DC converter to supply 12-volt DC to the motor when AC current is available. The motor shaft drives the pump.

The pump can be a peristaltic pump manufactured by APT Instruments having a capacity of 8-10 milliliters/min/100 grams of organ weight. The pump can be mounted to the outside of the box and the pump on-off switch can be mounted on the pump, thus providing ready access. A pump r.p.m. gauge can be mounted on the outside of the box. Pump r.p.m. is an indication of the flow rate of preservation fluid. A pressure cuff or pressure transducer may be mounted on the fluid supply line A or inside a T-connection in case a pressure transducer is used. A pressure readout gauge can be mounted on the box. Appropriate pressure, temperature and fluid flow alarms may be mounted on the box or in another convenient location such as on the cooler.

Other forms of pumps may also be used, for example, syringe pumps or centrifugal pumps may be readily substituted for the peristaltic pump. A centrifugal pump may allow for delivery of a constant flow of medium with low-shear, laminar flow. An example of such a pump is the Bio-Pump® Plus centrifugal pump from Medtronic, Inc. The Bio-Pump Plus has a vertical cutwater outlet design that reduces shear forces 40%.

The pump assembly 70 may be controlled by the system monitor 35 using pulse width modulation control or voltage variation depending on motor technology. The DC voltage is converted to a square-wave signal, alternating between fully on (nearly 12V) and zero, giving the motor a series of power pulses. If the switching speed of such a system is high enough, the motor will run at a steady speed. The motor speed of a pulse-width modulation system can be varied by adjusting the duty cycle of the system. If voltage variation is used, the DC voltage is increased or decreased to induce the desired speed.

The fluid channel 75 is used to connect the chamber 25, the fluid reservoir 65 and the pump assembly 70 together in a closed loop system. The fluid channel 75 may be made from flexible material such as tubing manufactured as USC class 6, available from many suppliers.

Quick connect-disconnect couplings can be used throughout the organ and tissue preservation and transport apparatus 10. One such fitting is manufactured by Colder Products and requires only one hand to operate. The fittings are FDA approved and are readily available.

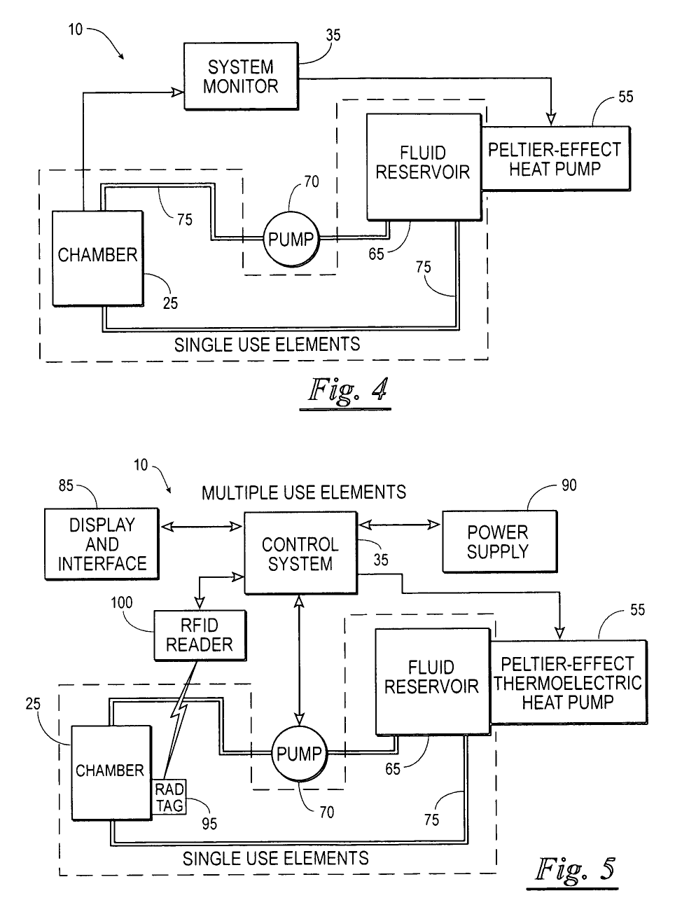

The assembly of the fluid channel 75 to the fittings may be accomplished by pushing the fluid channel 75 onto tapered bosses. An alternative option is to solvent bond or U.V. bond the fluid channel 75 to the tapered bosses. The fluid channel 75 and the other parts of the organ and tissue preservation and transport apparatus 10 are optionally disposable after a single use as shown in FIG. 4, thus disassembly of the tubing may be optional. Other parts of the organ and tissue preservation and transport apparatus 10, such as some or all disposable single-use elements, can be joined together in advance using tubing welded or glued into place to form connections.

In one embodiment, the pump assembly 70 may use a peristaltic pump. The fluid channel 75 defining the fluid input and output can be an unbroken length of tubing connected at one end to the quick connect fitting defining the outlet of the fluid reservoir 65 and at the other end to the quick connect fitting defining the inlet of the chamber 25. A bight or intermediate portion of the fluid channel 75 can be laid along the path traversed by the impeller of the peristaltic pump.

Referring again to FIG. 1, the organ and tissue preservation and transport apparatus 10 also includes the system monitor 35. The system monitor 35 registers and records the temperature of the portable casing 20, chamber 25 and/or organ 15 through the use of temperature sensors 80. The temperature sensors 80 may be placed on the interior wall of the portable casing 20 to provide information on the internal temperature of the entire system or the exterior wall of the portable casing 20 to provide information regarding the external environment of the system. Additionally, temperature sensors 80 may be placed on the external wall of the chamber 25 or the internal wall of the chamber 25. One or more contact points may also be placed on the organ's surface 15 providing attachment of temperature probes to measure the temperature of the organ 15. These sensors are exemplary and more or fewer sensors or different sensors may be appropriate in a given situation or device. Further, other sensors may be used for quantitative and qualitative variables such as flow, pressure, biochemistry (sodium, potassium, bicarbonate, calcium, glucose, ionized calcium), osmolarity, lactate and pH.

The system monitor 35 contains a front panel with a digital display readout of the preservation temperature or transport temperature. The information received by the system monitor 35 from the temperature sensors 80 on the portable casing 20, chamber 25 and/or organ 15 are communicated to a computer through a serial or analog communications component.

The system monitor 35 registers and records temperatures of each of the sensors. Recordation of the data provides later access and ability to print or download the data for future use in a preservation or transport record. The system monitor 35 may be programmed for processing the data, or alternatively, the system monitor 35 may solely record the data for later evaluation.

In processing the data, the record may include a temperature-time profile of the conditions the organ 15 was housed in for a specified period of time. Such information may be used in the subsequent determination of viability of the organ 15, documentation in a patient's record for future evaluation, or in other situations of interest.

The system monitor 35 may include an interactive user interface 85 including a display and data entry pad including keys associated with elements of the visual display or bear suitable icons or alphanumeric characters for data entry. The data entry pad can include software-programmable membrane key switches or other types of keys. Other types of data entry devices, such as a mouse, touchpad or other pointing device, voice recognition software, or others, can also be provided. The display of the interactive user interface 85 can provide the minimum value, the maximum value and continuous current value updates for all monitored parameters and metabolites sampled from the organ 15 and/or the medium. Using the interface 85, an operator can enter the mass and weight of the organ, the type of organ, the blood type, age, weight, or other characteristics of the donor and other pertinent data.

In one embodiment, the organ and tissue preservation and transport apparatus 10 includes a separate means for conveying the mass and weight of the organ, the type of organ, the blood type, age, weight, or other characteristics of the donor and other pertinent data. The separate device accompanies the portable casing 20 during transport. The means for conveying the information may be audio, visual, or textual and provide a background, pedigree, legacy, comments and/or information about the organ. Any information detailed in OPTN/UNOS Policy 5.0 including the Standardized Packaging and Transporting of Organs and Tissue Typing Materials is considered relevant for inclusion within the system. For example, information regarding the daily monitoring of vessels documented with security and temperature checks by the transplant center under OPTN/UNOS Policy 5.7.6.7 is considered relevant for inclusion in the system monitor 35 or other means accompanying the portable casing 20.

The system monitor 35 may also provide an alarm in situations where cooling fails. The system monitor 35 will record the alarm event within the record. For example, a significant rise of 1-2 degrees Centigrade per hour on the organ surface 15 will signal the system monitor 35 to record the alarm event. Additionally, the system monitor 35 may also provide an audio, visual, or textual signal of the alarm event or signal an external device of the alarm event.

During transport, the organ and tissue preservation and transport apparatus 10 may be internally powered electrically, mechanically, or pneumatically. The device may have a rechargeable power source or a replaceable power source. When not in transport, the device may be powered externally and/or recharge the internal power source from an external connection. For example, the electronic components of the organ and tissue preservation and transport apparatus 10 may be powered by a battery power supply 90 such as a rechargeable, sealed, lead, acid-type battery. The sealed, lead acid battery is safe to handle, has a long shelf life and a deep duty cycle. Embodiments may contain one or several battery slots based on performance determination and battery swap options keeping the entire weight of the organ and tissue preservation and transport apparatus 10 under 30 pounds. By allowing batteries to be exchanged, smaller and lighter weight batteries could be used keeping the system operable for hours or days.

The method of use set forth below describes the apparatus in use with the organ 15. It is expressly understood that other forms of tissue, including non-organ body parts, can be used with the apparatus and that they fall within the scope of the methods of use. Variations of the method below will be recognized by one skilled in the art as falling within the scope of the embodiments.

The portable casing 20 comprising the three main components of the chamber 25, the temperature control mechanism 30, and the system monitor 35 are provided to receive the organ 15. The organ may be flushed with a medium such as the “Wisconsin solution” described above. Other adequate solutions may be used, such as Vasosol, as described in U.S. Patent Application Publication 2002/0064768 which is incorporated by reference herein in its entirety.

The user partially fills the chamber 25 with the medium and places the organ 15 within the chamber 25. The medium may be stagnant during use. The medium may be circulated, mixed, or otherwise agitated. The medium may be perfused or delivered to the chamber or suprafused such that it is brought continuously in with contemporaneous degree so that there is always new medium within the chamber 25. Once the organ 15 is secured within the chamber 25, the user then fills the entire chamber 25 with the medium. Although not required, the user may change the medium on a temporal basis. The user attaches a temperature probe onto the organ 15 before the chamber 25 is sealed.

The user seals the chamber 25 and places the chamber 25 into the hollow portion 40 of the portable casing 20. The user places the temperature control mechanism 30 within the hollow portion 40 of the portable casing 20. The temperature control mechanism 30 maintains the temperature of the medium selected by the user at approximately 4-6 degrees Centigrade or at another desired temperature.

The user may provide an audio, visual, or textual background, pedigree, legacy, comments and/or information about the organ 15 through the system monitor 35 or other means accompanying the portable casing 20. As discussed above, any information detailed in OPTN/UNOS Policy 5.0 including the Standardized Packaging and Transporting of Organs and Tissue Typing Materials is considered relevant for inclusion within the system. For example, information regarding the daily monitoring of vessels documented with security and temperature checks by the transplant center under OPTN/UNOS Policy 5.7.6.7 is considered relevant for inclusion in the system monitor 35 or other means accompanying the portable casing 20.

Temporal assessments of the organ 15 are performed by the system monitor 35. The system monitor 35 may assess both quantitative and qualitative variables such as temperature, pressure, biochemistry of the medium or organ, osmolarity, pH and other variables. Assessments are recorded for later analysis, printing or downloading.

As shown schematically in FIG. 5, the organ and tissue preservation and transport apparatus 10 can be provided in the form of a disposable portion of single use elements and a reusable portion of elements so as to eliminate the need for sterilization of each individual element of the system. The disposable portion can include, for example, the chamber 25 and fluid channels that come into contact with the organ 15 or the medium and as such may require sterilization for multiple uses. The reusable elements may not need sterilization or sterilization may be difficult and time-consuming. If a Peltier-effect heat pump 55 is in use as the temperature control mechanism 30, the Peltier-effect heat pump 55 can be made part of the reusable portion of the organ and tissue preservation and transport apparatus 10 and the fluid reservoir 65 may be disposable as shown in FIG. 5. Alternatively, the Peltier-effect device may be part of a single use disposable component.

In one embodiment of the organ and tissue preservation and transport apparatus 10 shown in FIG. 5, an RFID tag 95 is secured to the chamber 25 as shown in FIG. 5, preferably in such a way that they cannot become separated. For example, it may be attached by adhesive or held in place by an overlying sheet or sleeve of plastic or other suitable material.

The RFID tag 95 can be configured (as by initial programming or by programming it at the time of use) to communicate the type of organ 15 the apparatus is designed to carry, labeled to carry, or carrying and to communicate a serial number for tracking the organ 15 and uniquely identifying it in an instrument event log. The RFID tag 95 can also have legible indicia indicating some or all of the same information, so the correct RFID tag 95 and chamber 25 will be used.

In one embodiment, an RFID tag 95 such as a passive transmitter that utilizes the energy content of a signal received from the RFID reader 100 to power its transmitter may be used. An active transmitter may also be used. The power can either be provided by a dedicated battery or transmitted by a connection made with the main battery of the apparatus when the portable casing 20 and components are assembled. An RFID reader 100 can be incorporated into the system monitor 35. The software can react to the RFID tag 95 transmission by automatically configuring the system monitor 35 to suit the container (size and/or organ type) and to create a uniquely identified log file from the serial number transmitted by the RFID tag 95.

Using an RFID tag 95 to automatically configure the system monitor 35 provides parameters which may vary by organ type or size or manner to be tailored to the specific organ 15 being transported. Parameters such as flow rate, steady state temperature, temperature profiles, nutrient levels, metabolite levels, maximum transport time allowed, or other parameters can be measured or calculated and properly maintained, without the need for the user to select and implement appropriate parameters.

The exemplary embodiments shown in the drawings and described above are exemplary of numerous embodiments that may be made within the scope of the appended claims. It is contemplated that numerous other configurations of the portable casing 20, chamber 25, temperature control mechanism 30, system monitor 35, power system 90 and RFID tag 95 can be used and fall within the scope of embodiments. In addition, the material and composition of each component may be selected from numerous materials and compositions other than those specifically disclosed. In short, it is the applicants' intention that the scope of the patent issuing will be limited only by the scope of the appended claims.

What is claimed is:

1. An organ, tissue, and limb preservation and transport apparatus comprising:
a chamber defining an interior space sized and shaped to receive an organ;
means for controlling the temperature of the chamber; and
means for isolating the chamber from an external environment.

2. The apparatus of claim 1, wherein at least a portion of the chamber is composed of a sterilizable material.

3. The apparatus of claim 1, wherein at least a portion of the chamber is composed of a flexible material.

4. The apparatus of claim 1, further comprising means for maintaining the organ in a substantially shock resistant state within the chamber.

5. The apparatus of claim 1, further comprising a medium disposed within the chamber.

6. The apparatus of claim 5, further comprising means for agitating the medium within the chamber.

7. The apparatus of claim 5, wherein the medium contains at least one free radical scavenger.

8. An organ and tissue preservation and transport apparatus, comprising:
a first chamber defining an interior space sized and shaped for receiving an organ, the chamber formed at least in part from a first material having at least one heat transfer characteristic;
a second chamber defining an interior space that substantially surrounds an outer surface of the first chamber, the second chamber formed at least in part from a second material having at least one heat transfer characteristic; and
a third chamber defining an interior space that substantially surrounds an outer surface of the second chamber, the third chamber formed at least in part from a third material having at least one heat transfer characteristic;
wherein the at least one heat transfer characteristic of the first material and the at least one heat transfer characteristic of the second material are substantially different.

9. The apparatus of claim 8, wherein the second material is formed at least in part from a sterilizable insulating material.

10. The apparatus of claim 8, wherein the first material is formed at least in part from a bio-compatible material.

11. The apparatus of claim 8, further comprising a fourth chamber defining an interior space that substantially surrounds an outer surface of the third chamber.

12. The apparatus of claim 11, wherein the inner surface of the fourth chamber is formed at least in part from a fourth material having at least one heat transfer characteristic substantially different from the at least one heat transfer characteristic of the second material.

13. The apparatus of claim 8, wherein the first chamber contains a first medium.

14. The apparatus of claim 13, wherein the second chamber contains a second medium.

15. The apparatus of claim 14, wherein the first medium is substantially different from the second medium.

16. The apparatus of claim 14, wherein the first medium is substantially the same as the second medium.

17. An organ and tissue preservation and transport apparatus, comprising:
a portable casing having a hollow interior;
a chamber positioned in the hollow interior of the portable casing, the chamber defining an interior space sized and shaped to receive an organ;
a medium disposed within the chamber;
a first sensor disposed in the chamber capable of providing at least one quantitative measurement;
a second sensor positionable about the organ received in the chamber and capable of providing at least one quantitative measurement;
a temperature control mechanism for controlling the temperature of the interior space of the chamber; and
a system monitor for registering the at least one quantitative measurement of the first sensor and the at least one quantitative measurement of the second sensor.

18. The apparatus of claim 17, wherein the temperature control mechanism is a heat pump.

19. The apparatus of claim 17, wherein the temperature control mechanism is a second chamber having at least one opening for circulating a heat-conducting medium through the interior space of the front chamber.
